(19) United States
(12) Patent Application Publication
(10) Pub. No.: US 2021/0384788 A1
(43) Pub. Date: Dec. 9, 2021

(54) I-PIN STATOR WITH PLANAR WINDING CONNECTION

(71) Applicant: MAGNA INTERNATIONAL INC., Aurora (CA)

(72) Inventors: Martin WINTER, Dietach (AT); Gerd SCHLAGER, Kefermarkt (AT)

(21) Appl. No.: 17/287,257

(22) PCT Filed: Oct. 22, 2019
(86) PCT No.: PCT/CA2019/051496

§ 371 Date: Apr. 21, 2021

Related U.S. Application Data
(60) Provisional application No. 62/748,855, filed on Oct. 22, 2018.

(51) Int. Cl. H02K 3/50; H02K 9/19; H02K 9/22

(52) U.S. Cl. CPC H02K 3/50; H02K 9/19; H02K 2203/09; H02K 2203/03; H02K 9/227

(57) ABSTRACT

A stator for an electromagnetic machine includes a plurality of bus bars of copper, each extending parallel to one another between a first end and a second end. A first circuit board abuts the first end of the bus bars and includes a first substrate and a first electrically conductive layer disposed thereupon with a plurality of first contact terminals in physical and electrical communication with each of the bus bars. A similar second circuit board abuts the second end of each of the bus bars and includes a second substrate and second contact terminals in physical and electrical communication with each of the bus bars. The substrates of the circuit boards are electrical insulators and are good conductors of heat. A heat sink abuts each of the substrates of the circuit boards for removing heat from the circuit boards and from the bus bars.

### CROSS-REFERENCE TO RELATED APPLICATIONS

This PCT International Patent application claims the benefit of and priority to U.S. Provisional Patent Application Ser. No. 62/748,855, filed on Oct. 22, 2018, titled “I-Pin Stator With Planar Winding Connection,” the entire disclosure of which is hereby incorporated by reference.

### FIELD

The present disclosure relates generally to a stator winding for an electromagnetic machine such as an electric motor or generator.

### BACKGROUND

Electromagnetic machines, such as electric motors or generators, commonly include a stationary part called a stator. Energy flows through the stator to or from a moving component, such as a rotor that rotates. Stators commonly include a magnetic core and one or more electrical conductors that are windings of conductive wire. An electrical current is applied or induced in the electrical conductors to transfer energy to or from the rotating component. In some machine designs, it is advantageous for the metal conductors to be tightly spaced in a back-and-forth configuration, requiring hairpin or U-pin bends. Such U-pin bends are difficult and costly to produce and can add space and mass to the ends of a stator due to bending radii. Stators in electromagnetic machines may also require cooling considerations to remove excess heat generated in the machine.

### SUMMARY

A stator for an electromagnetic machine is provided. The stator includes a plurality of bus bars of electrically conductive material each extending parallel to one another and between a first end and a second end opposite the first end. A first circuit board abuts the bus bars and extends perpendicularly thereto. The first circuit board includes a first electrically conductive layer disposed upon a first substrate. The first electrically conductive layer includes a plurality of first contact terminals in physical and electrical communication with the first end of the bus bars. A first heat sink abuts the first substrate of the first circuit board opposite the first electrically conductive layer, with the first substrate disposed between the first electrically conductive layer and the first heat sink. The first heat sink is configured to remove heat from the first circuit board and from the bus bars.

### BRIEF DESCRIPTION OF THE DRAWINGS

Further details, features and advantages of designs of the invention result from the following description of embodiment examples in reference to the associated drawings.

FIG. 1 is a cross-sectional view of a stator of the present disclosure.

### DETAILED DESCRIPTION

Recurring features are marked with identical reference numerals in the FIGURES, in which an example embodiment of a stator 20 for an electromagnetic machine, such as a motor or generator, is disclosed.

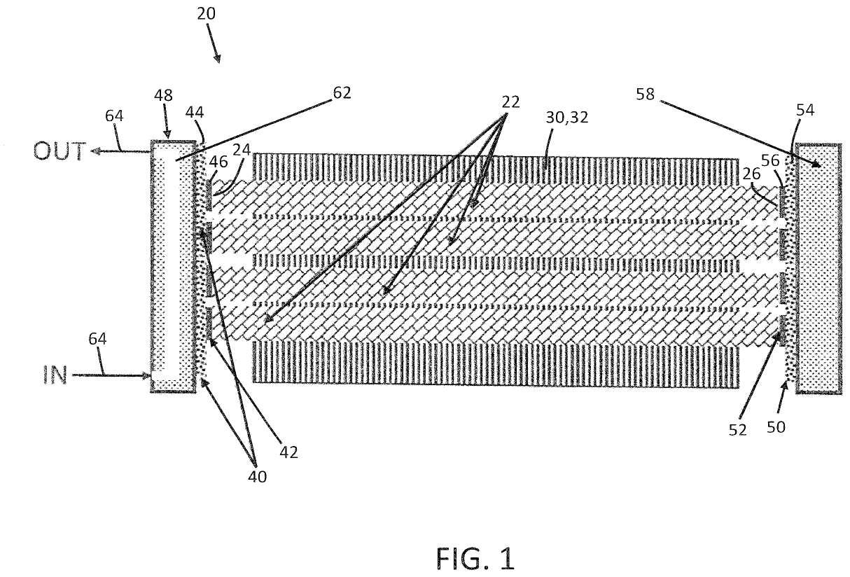

As shown in FIG. 1, the stator 20 includes a plurality of bus bars 22 of electrically conductive material each extending parallel to one another and between a first end 24 and a second end 26 opposite the first end 24. The bus bars 22 are preferably formed of copper, but may be formed from other metals or alloys. The bus bars 22 may have an elongate shape, with a relatively small cross-section compared with the length between the ends 24, 26. The bus bars 22 may be solid or hollow and may have a constant or a variable cross section. The bus bars 22 may be formed, for example, as one or more extrusions or as segments of wire. The bus bars 22 extend adjacent to a magnetic core 30 having a high magnetic permeability and including a plurality of lamination plates 32 stacked and parallel to one another between the first end 24 and the second end 26 of the bus bars 22. The bus bars 22 may extend through holes, slots, or other such features in the magnetic core 30. As shown in FIG. 1, the bus bars 22 may each extend substantially perpendicularly to the lamination plates 32 of the magnetic core 30.

A first circuit board 40 abuts the plurality of bus bars 22 and extends perpendicularly thereto. The first circuit board 40 includes a first electrically conductive layer 42 disposed upon a first substrate 44, with the first electrically conductive layer 42 of the first circuit board 40 including a plurality of first contact terminals 46 in physical and electrical communication with the first end 24 of the bus bars 22. Each of the first contact terminals 46 is in contact with a corresponding one of the bus bars 22. The first electrically conductive layer 42 may be, for example, a layer of metal such as copper. The first substrate 44 is preferably a good conductor of heat and is preferably an electrical insulator. The first substrate 44 may include a ceramic material and may be entirely or substantially entirely made of a ceramic material. Alternatively, the first substrate 44 may be an insulated metal substrate (IMS) including an electrically insulating layer disposed between a carrier of metal and the first electrically conductive layer 42. The insulating layer in such an insulated metal substrate (IMS) may be, for example, a polymer material such as plastic or rubber, and/or a ceramic material.

As shown in FIG. 1, a first heat sink 48 abuts the first substrate 44 of the first circuit board 40 opposite the first electrically conductive layer 42, with the first substrate 44 disposed between the first electrically conductive layer 42 and the first heat sink 48. The first heat sink 48 is configured to remove heat from the first circuit board 40 and from the bus bars 22. In other words, heat generated in the bus bars 22 is transferred through the first circuit board 40 and into the first heat sink 48.

As also shown in FIG. 1, the stator 20 also includes a second circuit board 50 abutting the bus bars 22 and extending perpendicularly thereto. The second circuit board 50 may be similar or identical in construction to the first circuit board 40. The second circuit board 50 may include a second electrically conductive layer 52 disposed upon a second substrate 54. The second electrically conductive layer 52 of the second circuit board 50 may include a plurality of second contact terminals 56 in physical and electrical communication with the second end 26 of the bus bars 22.

A second heat sink 58 abuts the second substrate 54 of the second circuit board 50 opposite the second electrically conductive layer 52, with the second substrate 54 disposed between the second electrically conductive layer 52 and the second substrate 54. The second heat sink 58 is configured to remove heat from the second circuit board 50 and from the bus bars 22.

In an alternative embodiment, the stator 20 may include only a first circuit board 40 on the first end 24 of the bus bars 22. The second end 26 may include other termination structures to enable electrical communication between two or more of the bus bars 22 and/or between one or more of the bus bars 22 and an external conductor. Such other termination structures may include, for example, a U-bend or a conducive base, such as a metal plate.

In accordance with an aspect of the disclosure, either or both of the heat sinks 48, 58 may include one or more structures, such as fins, to increase surface area and to facilitate transfer of heat to a fluid in contact therewith. The fluid may be a gas, such as air and/or a liquid. Furthermore, either or both of the heat sinks 48, 58 may include a surface with a high roughness to facilitate transfer of heat to a fluid in contact therewith.

In accordance with an aspect of the disclosure, and as shown in FIG. 1, either or both of the heat sinks 48, 58 may include a fluid passage 62 for transferring heat to a liquid coolant flowing therethrough. The fluid passage 62 may be in fluid communication with fluid conduits 64, as shown in FIG. 1. A cooling fluid, such as water or glycol, may be circulated through one or both of the heat sinks 48, 58 to remove heat therefrom.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A stator for an electromagnetic machine comprising:
a plurality of bus bars of electrically conductive material each extending parallel to one another and between a first end and a second end opposite said first end;
a first circuit board abutting said plurality of bus bars and including a first electrically conductive layer disposed upon a first substrate, with said first electrically conductive layer of said first circuit board including a plurality of first contact terminals in physical and electrical communication with said first end of said bus bars; and
a first heat sink abutting said first substrate of said first circuit board opposite said first electrically conductive layer, with said first substrate disposed between said first electrically conductive layer and said first heat sink, said first heat sink being configured to remove heat from said first circuit board and from said bus bars.

2. The stator of claim 1, wherein said first circuit board extends perpendicularly to said bus bars.

3. The stator of claim 1, further comprising:
a second circuit board abutting said plurality of bus bars and including a second electrically conductive layer disposed upon a second substrate, with said second electrically conductive layer of said second circuit board including a plurality of second contact terminals in physical and electrical communication with said second end of said bus bars.

4. The stator of claim 3, further comprising:
a second heat sink abutting said second substrate of said second circuit board opposite said second electrically conductive layer, with said second substrate disposed between said second electrically conductive layer and said second heat sink, said second heat sink being configured to remove heat from said second circuit board and from said bus bars.

5. The stator of claim 4, wherein said second heat sink includes fins or a surface with a high roughness to facilitate transfer of heat to a fluid in contact therewith.

6. The stator of claim 4, wherein said second heat sink includes a fluid passage for transferring heat to a liquid coolant flowing therethrough.

7. The stator of claim 3, wherein said second circuit board extends perpendicularly to said bus bars.

8. The stator of claim 3, wherein at least one of said first substrate of said first circuit board or said second substrate of said second circuit board is an insulated metal substrate (IMS) including an electrically insulating layer disposed between a carrier of metal and a respective one of the first electrically conductive layer or the second electrically conductive layer.

9. The stator of claim 1, wherein said first substrate of said first circuit board includes a ceramic material.

10. The stator of claim 1, wherein said first substrate of said first circuit board is an insulated metal substrate (IMS) including an electrically insulating layer disposed between a carrier of metal and the first electrically conductive layer.

11. The stator of claim 1, wherein said first heat sink includes structures to increase surface area and to facilitate transfer of heat to a fluid in contact therewith.

12. The stator of claim 1, wherein said first heat sink has a surface with a high roughness to facilitate transfer of heat to a fluid in contact therewith.

13. The stator of claim 1, wherein said first heat sink includes a fluid passage for transferring heat to a liquid coolant flowing therethrough.

14. The stator of claim 1, further comprising a magnetic core including a plurality of lamination plates stacked and parallel to one another and disposed adjacent said bus bars between said first end and said second end.

15. The stator of claim 14, wherein said bus bars each extend substantially perpendicularly to said lamination plates of said magnetic core.

16. The stator of claim 1, wherein the first electrically conductive layer comprises metal.

17. The stator of claim 16, wherein the first electrically conductive layer comprises copper.

18. An electric motor comprising a stator, the stator including:
a plurality of bus bars of electrically conductive material each extending parallel to one another and between a first end and a second end opposite said first end;
a first circuit board abutting said plurality of bus bars and including a first electrically conductive layer disposed upon a first substrate, with said first electrically conductive layer of said first circuit board including a plurality of first contact terminals in physical and electrical communication with said first end of said bus bars; and
a first heat sink abutting said first substrate of said first circuit board opposite said first electrically conductive layer, with said first substrate disposed between said first electrically conductive layer and said first heat sink, said first heat sink being configured to remove heat from said first circuit board and from said bus bars.

19. The electric motor of claim 18, further comprising:
a second circuit board abutting said plurality of bus bars, said second circuit board including a second electrically conductive layer disposed upon a second substrate, with said second electrically conductive layer of said second circuit board including a plurality of second contact terminals in physical and electrical communication with said second end of said bus bars.

20. The electric motor of claim 18, further comprising:
a second heat sink abutting said second substrate of said second circuit board opposite said second electrically conductive layer, with said second substrate disposed between said second electrically conductive layer and said second heat sink, said second heat sink being configured to remove heat from said second circuit board and from said bus bars.
